(19) United States
(12) Patent Application Publication
(10) Pub. No.: US 2013/0104711 A1
(43) Pub. Date: May 2, 2013

(54) PUNCHING DEVICE FOR BRAKE SACK AND METHOD FOR PUNCHING THE SAME

(71) Applicant: CHENG-SHIUN WU, Tu-Cheng (TW)

(72) Inventor: CHENG-SHIUN WU, Tu-Cheng (TW)

(73) Assignee: HON HAI PRECISION INDUSTRY CO., LTD., Tu-Cheng (TW)

(21) Appl. No.: 13/585,955

(22) Filed: Aug. 15, 2012

(30) Foreign Application Priority Data
Nov. 1, 2011 (TW) 100139859

(51) Int. Cl. B26F 1/02; B26F 1/14

(52) U.S. Cl. 83/34; 83/613

(57) ABSTRACT

A punching device includes a worktable, a rotatable base, a puncher and a punching member. The worktable includes a loading plate, a planar plate, and a plurality of supporting rods. The plurality of supporting rods interconnects the loading plate and the planar plate, the loading plate defines a blanking hole thereof, the planar plate defines a guiding hole thereof. The rotatable base partially is received in the guiding hole and defines a first surface facing the blanking hole and a blind hole thereon, the rotatable base is capable of rotating about and moving along an axis of the blind hole. The puncher is fixed in the blind hole. The punching member includes a punching portion and defines a sleeving hole thereof. The punching member is sleeved on the puncher via the sleeving hole. The present disclosure further discloses a punching method thereof.

### BACKGROUND

1. Technical Field

The present disclosure relates to punching devices, and particularly to a punching device for a brake sack and method for punching the brake sack.

2. Description of Related Art

In order to eliminate astigmatism of optical lens module, a brake sack with a circular hole in a middle portion thereof is employed. The brake sack is located between two lenses to shield an emitting light. The circular hole of the brake sack is formed by punching for one shot. However, a puncher and a punching member employed here may be asymmetrical after a long period of usage, this results in an uneven or deformation of the brake sack fabricated by the puncher and the punching member.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is a cross-sectional, schematic view of a first embodiment of a punching device.

FIG. 2 is a cross-sectional, schematic view of the punching device of FIG. 1 during punching in a first state.

FIG. 3 is a cross-sectional, schematic view of the punching device of FIG. 1 during punching in a second state.

FIG. 4 is a cross-sectional, schematic view of the punching device of FIG. 1 during punching in a third state.

FIG. 5 is a flowchart of an embodiment of a punching method.

FIG. 6 is a cross-sectional, schematic view of a second embodiment of a punching device.

### DETAILED DESCRIPTION

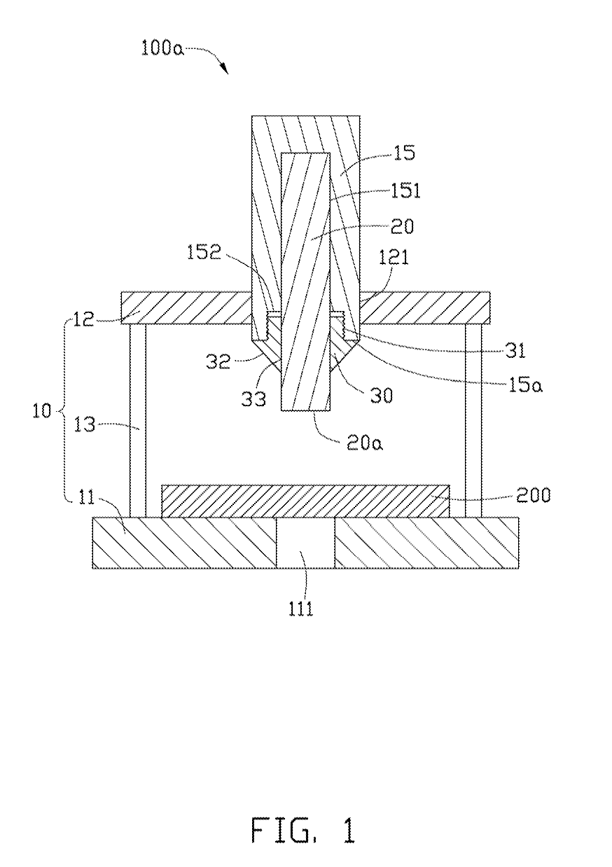

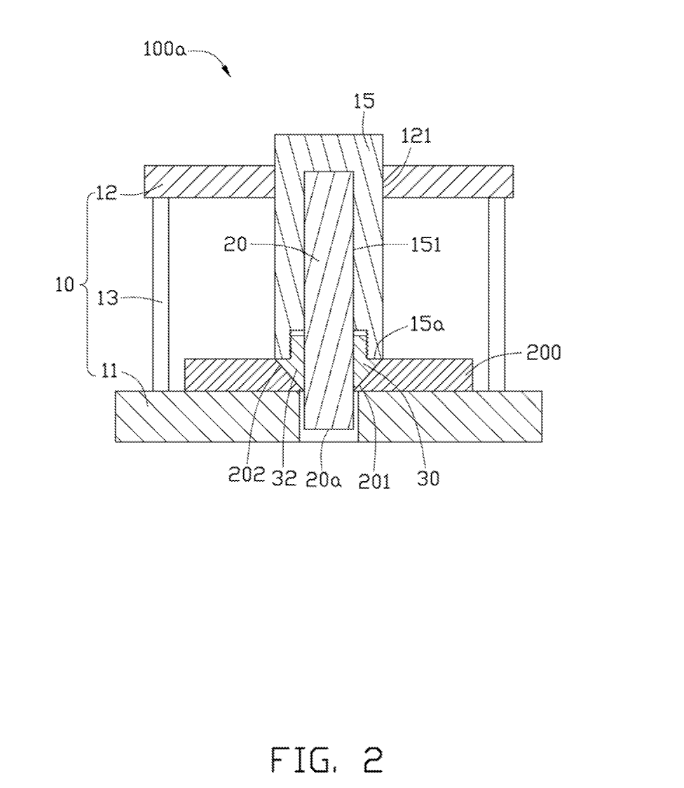

FIG. 1 shows a first embodiment of a punching device 100a for punching a brake sack 200. The punching device 100a includes a worktable 10, a rotatable base 15, a puncher 20, and a punching member 30. Referring also to FIG. 2, the punching device 100a is capable of punching a circular hole 201 on the brake sack 200 and forms a shape on the brake sack 200 surrounding the circular hole 201 corresponding to the punching member 30.

The worktable 10 includes a loading plate 11, a planar plate 12, and a plurality of supporting rods 13. The loading plate 11 and the planar plate 12 are parallel to each other. The plurality of supporting rods 13 interconnects the loading plate 11 and the planar plate 12. The loading plate 11 defines a blanking hole 111 thereof. The planar plate 12 defines a guiding hole 121 thereof corresponding to the blanking hole 111.

The rotatable base 15 is substantially cylindrical and partially received in the guiding hole 121. The rotatable base 15 includes a first surface 15a facing the brake sack 200, and defines a screw hole 152 on the first surface 15a along a direction perpendicularly to the first surface 15a. The rotatable base 15 further defines a round blind hole 151 on a bottom surface of the screw hole 152. The blind hole 151 is coaxial with the screw hole 152. A diameter of the blind hole 151 is less than a diameter of the screw hole 152. The rotatable base 15 is capable of rotating about an axis of the blind hole 151.

The puncher 20 is latched and partially received in the blind hole 151. The puncher 20 is substantially cylindrical and includes a second surface 20a facing the brake sack 200. The puncher 20 is capable of punching the circular hole 201 on the brake sack 200.

The punching member 30 includes a connecting portion 31 and a punching portion 32. In the embodiment, the connecting portion 31 is substantially cylindrical and forms screw threads on a side surface thereof. The punching portion 32 is substantially conical and coaxial with the connecting portion 31. The space of the bottom surface of the punching portion 32 is greater than the space of the bottom surface of the connecting portion 31. The punching member 30 defines a sleeving hole 33 penetrating thereof along the axis of the connecting portion 31. A diameter of the sleeving hole 33 is equal to a diameter of the puncher 20. The punching member 30 is sleeved on the puncher 20 via the sleeving hole 33, and fixed to the rotatable base 15 via the connecting portion 31.

In assembly, the puncher 20 is mounted in the blind hole 151 of the rotatable base 15. The punching member 30 is sleeved on the puncher 20 via the sleeving hole 33. The screw threads of the connecting portion 31 engage in the screw hole 152. The rotatable base 15 is mounted on the worktable 10 and capable of sliding along the guiding hole 121. A length of the puncher 20 exposed out of the rotatable base 15 is greater than a thickness of the brake sack 200 and less than two times of the thickness of the brake sack 200.

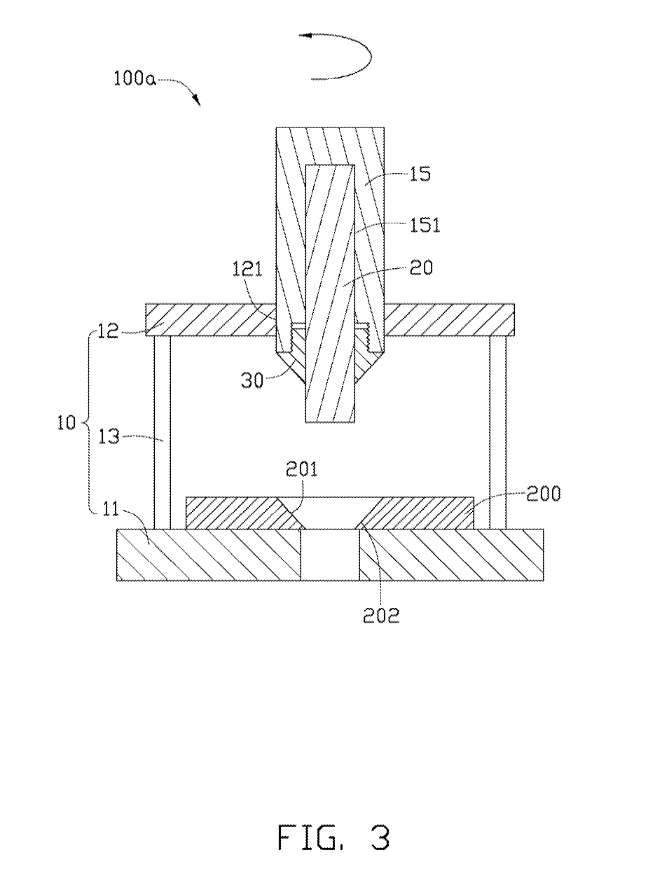

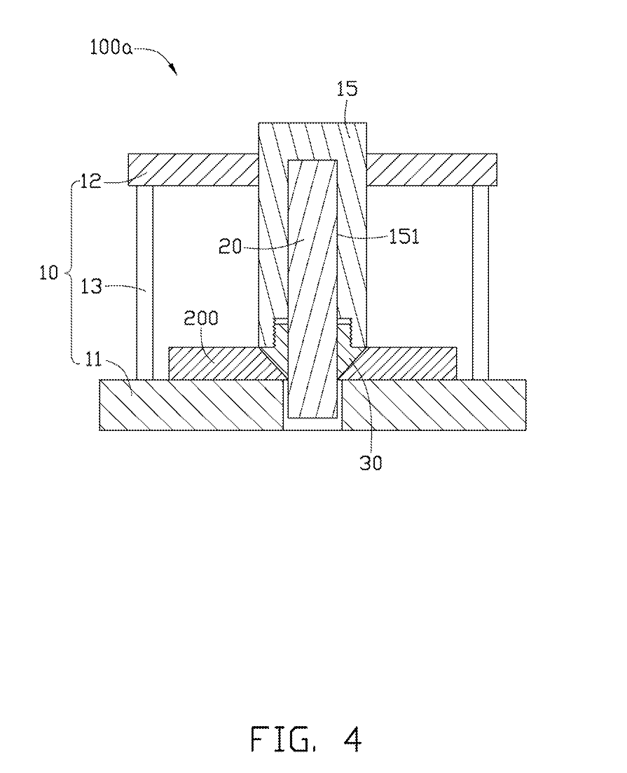

Referring to FIGS. 2 through 4, when in work, the brake sack 200 is set on the loading plate 11, the rotatable base 15 moves linearly toward the brake sack 20 along the guiding hole 121, and drives the puncher 20 and the punching member 30 to punch the brake sack 200 for a first time, the circular hole 201 is formed on the brake sack 200 by the puncher 20. Materials got off the brake sack 200 follows through the blanking hole 111. An annular surface 202 surrounding the circular hole 201 is formed on the brake sack 200 by the punching portion 32 of the punching member 30.

The rotatable base 15 moves linearly away from the brake sack 200 along the guiding hole 121. The rotatable base 15 rotates along the axis of the blind hole 151 for about 180 degrees. Then, the rotatable base 15 moves linearly toward the brake sack 20 along the guiding hole 121, and drive the puncher 20 and the punching member 30 to punch the brake sack 200 for a second time. As the puncher 20 and the punching member 30 are coaxial with the blind hole 151, the puncher 20 and the punching member 30 rotate for about 180 degrees in the steps described above. The brake sack 200 after the second punch obtains a high degree of symmetry. And the punching positions of the first and second punches keep the same because the rotatable base 15 is guided by the same guiding hole 121 during the first and second punching process.

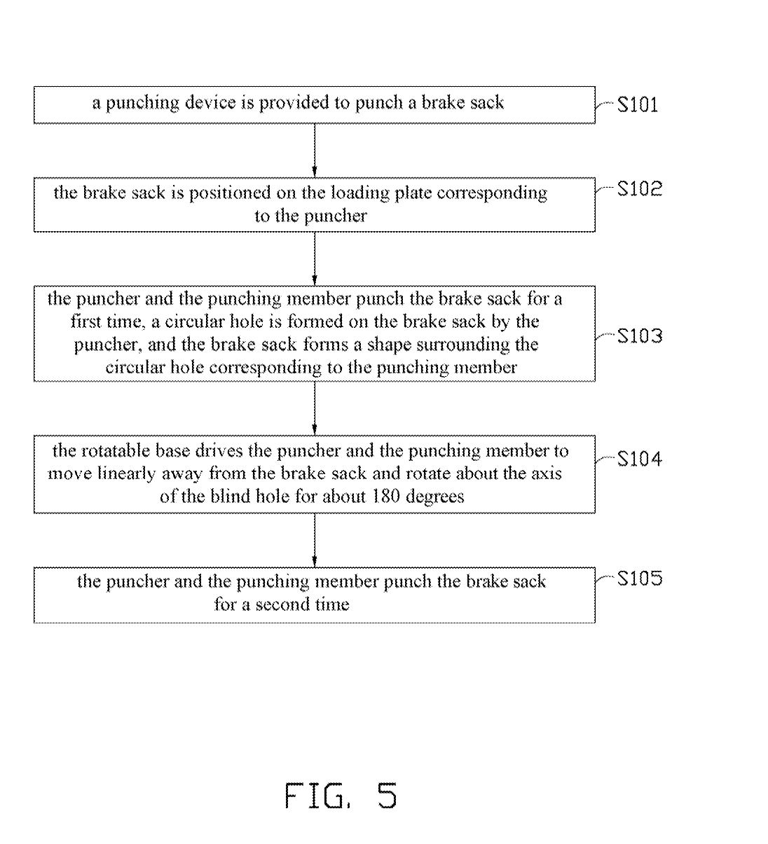

Referring also to FIG. 5, a flowchart of an embodiment of a punching method is shown, including steps as follows:

S101: A punching device 100a is provided to punch a brake sack 200. The punching device 100a includes a worktable 10, a rotatable base 15, a puncher 20, and a punching member 30. The worktable 10 includes a loading plate 11, a planar plate 12 and a plurality of supporting rods 13. The loading plate 11 and the planar plate 12 are parallel to each other. The plurality of supporting rods 13 interconnects the loading plate 11 and the planar plate 12. The loading plate 11 defines a blanking hole 111 thereof. The planar plate 12 defines a guiding hole 121 thereof corresponding to blanking hole 111. The brake sack 200 is set on the loading plate 11. The rotatable base 15 includes a first surface 15a facing the brake sack 200, and defines a screw hole 152 on the first surface 15a along a direction perpendicularly to the first surface 15a. The rotatable base 15 further defines a round blind hole 151 on a bottom surface of the screw hole 152. The blind hole 151 is coaxial with the screw hole 152. A diameter of the blind hole 151 is less than a diameter of the screw hole 152. The rotatable base 15 is capable of rotating about an axis of the blind hole 151. The puncher 20 is mounted in the blind hole 151 of the rotatable base 15. The punching member 30 includes a punching portion 32 and defines a sleeving hole 33 on the punching member 30. The punching member 30 is sleeved on the puncher 20 via the sleeving hole 33. The punching portion 32 is capable of punching the brake sack 200.

S102: The brake sack 200 for punching is positioned on the loading plate 11 corresponding to the puncher 20.

S103: The puncher 20 and the punching member 30 punch the brake sack 200 for a first time, a circular hole 201 is formed on the brake sack 200 by the puncher 20, and the brake sack 200 forms a shape surrounding the circular hole 201 corresponding to the punching member 30.

S104: The rotatable base 15 drives the puncher 20 and the punching member 30 to move linearly away from the brake sack 200 and rotate about the axis of the blind hole 151 for about 180 degrees.

S105: The puncher 20 and the punching member 30 punch the brake sack 200 for a second time.

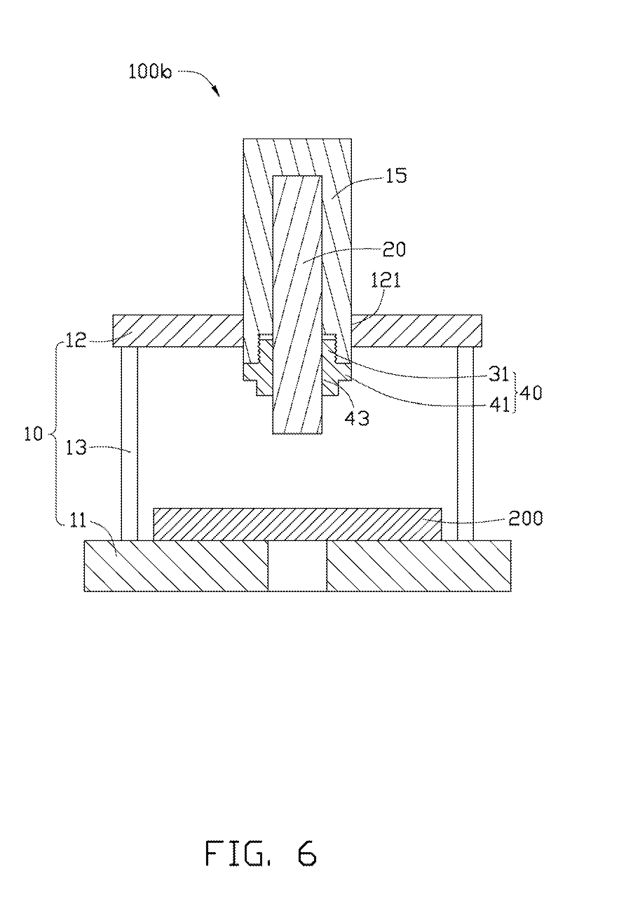

FIG. 6 shows a second embodiment of a punching device 100b which is similar to the punching device 100a in structure. The difference between them is that, a punching member 40 of the punching device 100b includes a connecting portion 31 and a punching portion 41. The connecting portion 31 is substantially cylindrical and includes screws around a periphery thereof. The punching portion 41 is substantially in a stepped shaft shape, and coaxially connected to the connecting portion 31 with a big end thereof. A space of the end surface of the big end of the punching portion 41 is greater than a space of an end surface of the connecting portion 31. The punching member 40 defines a sleeving hole 43 penetrating thereof along the axis of the connecting portion 31. A diameter of the sleeving hole 43 is equal to a diameter of the puncher 20.

The punching method adopted by the punching device 100b is the same as the punching method of the punching device 100a.

The punching member 30 and the punching member 40 may be in other shapes due to the fabricated shape of the brake sack 200.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A punching device, comprising:
a worktable comprising a loading plate, a planar plate and a plurality of supporting rods, wherein the loading plate and the planar plate are parallel to each other, the plurality of supporting rods interconnect the loading plate and the planar plate, the loading plate defines a blanking hole thereof, the planar plate defines a guiding hole thereof corresponding to the blanking hole;
a rotatable base partially received in the guiding hole of the planar plate, the rotatable base defining a first surface facing the blanking hole and a blind hole on the rotatable base, the rotatable base being capable of rotating about an axis of the blind hole;
a puncher fixed in the blind hole of the rotatable base; and
a punching member comprising a punching portion and defines a sleeving hole thereof, wherein the punching member is sleeved on the puncher via the sleeving hole;
wherein the rotatable base is configured for driving the puncher and the punching member to move toward and away from the loading plate.

2. The punching device of claim 1, wherein the puncher is substantially cylindrical and comprises a second surface facing a brake sack placed upon the blanking hole, the puncher is capable of punching a circular hole on the brake sack.

3. The punching device of claim 2, wherein the punching member is fixed to the rotatable base and capable of forming a shape on the brake sack surrounding the circular hole corresponding to the punching portion.

4. The punching device of claim 3, wherein the punching member further comprises a connecting portion coaxially connected to the punching portion, the connecting portion is substantially cylindrical, the punching portion is substantially conical, the punching member is fixed to the rotatable base via the connecting portion.

5. The punching device of claim 4, wherein a space of the bottom surface of the punching portion is greater than that of the connecting portion, the sleeving hole penetrates the punching member along an axis of the connecting portion, a diameter of the sleeving hole is equal to a diameter of the puncher.

6. The punching device of claim 5, wherein the rotatable base further defines a screw hole on the first surface along a direction perpendicular to the first surface, the blind hole is defined on a bottom surface of the screw hole and is coaxial with the blind hole, a diameter of the blind hole is less than that of the screw hole, the connecting portion forms screws on a periphery thereof and engages in the screw hole.

7. The punching device of claim 3, wherein the punching member further comprises a connecting portion coaxially connected to the punching portion, the connecting portion is substantially cylindrical, the punching portion is substantially in a stepped shaft shape and connected to the connecting portion with a big end thereof.

8. The punching device of claim 7, wherein a space of the end surface of the big end of the punching portion is greater than a space of an end surface the connecting portion, the sleeving hole penetrates the punching member along the axis of the connecting portion, and a diameter of the sleeving hole is equal to a diameter of the puncher.

9. A punching device, comprising:
a worktable comprising a loading plate and a planar plate, wherein the loading plate and the planar plate are fixedly spaced from each other, the loading plate defines a blanking hole thereof, the planar plate defines a guiding hole thereof corresponding to the blanking hole;
a rotatable base partially received in the guiding hole of the planar plate, the rotatable base defining a first surface facing the blanking hole, a screw hole on the first surface along a direction perpendicularly to the first surface and a blind hole on a bottom surface of the screw hole, the rotatable base being capable of rotating about and moving along an axis of the blind hole;
a puncher fixed in the blind hole of the rotatable base; and
a punching member comprising a connecting portion and a punching portion coaxially connected to the connecting portion, wherein the connecting portion engages in the screw hole of the rotatable base, the punching member further defines a sleeving hole thereof and is sleeved on the puncher via the sleeving hole.

10. The punching device of claim 9, wherein a diameter of the blind hole is less than that of the screw hole, the connecting portion forms screws on a periphery thereof and engages in the screw hole via the screws.

11. The punching device of claim 9, wherein the puncher is substantially cylindrical and comprises a second surface facing a brake sack placed upon the blanking hole, the puncher is capable of punching a circular hole on the brake sack.

12. The punching device of claim 11, wherein the connecting portion is substantially cylindrical, the punching portion is capable of forming a shape on the brake sack surrounding the circular hole corresponding to the punching portion.

13. The punching device of claim 12, wherein the punching portion is substantially conical, a space of the bottom surface of the punching portion is greater than that of the connecting portion, the sleeving hole penetrates the punching member along the axis of the connecting portion, and a diameter of the sleeving hole is equal to a diameter of the puncher.

14. The punching device of claim 9, wherein the connecting portion is substantially cylindrical, the punching portion is substantially in a stepped shaft shape and connected to the connecting portion with a big end thereof.

15. The punching device of claim 14, wherein a space of the end surface of the big end of the punching portion is greater than a space of an end surface the connecting portion, the sleeving hole penetrates the punching member along the axis of the connecting portion, and a diameter of the sleeving hole is equal to a diameter of the puncher.

16. A punching method comprising:
providing a punching device comprising: a worktable comprising a loading plate and a planar plate, wherein the loading plate and the planar plate are fixedly spaced from each other, the loading plate defines a blanking hole thereof, the planar plate defines a guiding hole thereof corresponding to the blanking hole; a rotatable base partially received in the guiding hole of the planar plate, the rotatable base defining a first surface facing the blanking hole, a screw hole on the first surface along a direction perpendicularly to the first surface and a blind hole on a bottom surface of the screw hole, the rotatable base being capable of rotating along an axis of the blind hole; a puncher fixed in the blind hole of the rotatable base; and a punching member comprising a punching portion and defines a sleeving hole thereof, wherein the punching member is sleeved on the puncher via the sleeving hole;
positioning a brake sack on the loading plate corresponding to the puncher;
driving the puncher and the punching member by the rotatable base to punch the brake sack for a first time, wherein a circular hole is formed on the brake sack by the puncher, and the brake sack forms a shape surrounding the circular hole corresponding to the punching member;
driving the puncher and the punching member by the rotatable base to move linearly away from the brake sack and rotate about the axis of the blind hole for about 180 degrees; and
driving the puncher and the punching member by the rotatable base to punch the brake sack for a second time.
